(19) United States
(12) Patent Application Publication
(10) Pub. No.: US 2024/0042880 A1
(43) Pub. Date: Feb. 8, 2024

(54) METHODS AND SYSTEMS FOR FLYWHEEL-BASED HIGH-POWER ELECTRIC VEHICLE CHARGING

(71) Applicant: REVTERRA CORPORATION, Houston, TX (US)

(72) Inventors: BenMaan I. Jawdat, Houston, TX (US); Arsalan Hekmati, Houston, TX (US)

(21) Appl. No.: 18/365,181

(22) Filed: Aug. 3, 2023

Related U.S. Application Data
(60) Provisional application No. 63/486,985, filed on Feb. 25, 2023.
(60) Provisional application No. 63/394,886, filed on Aug. 3, 2022.

(51) Int. Cl. B60L 53/56; H02J 15/00; H02J 7/14

(52) U.S. Cl. CPC B60L 53/56; H02J 15/007; H02J 7/14; B60L 2210/30; B60L 2220/14

(57) ABSTRACT

A system for storing input power and providing output power, such as for use with electric vehicle charging, can include an alternating current motor, a flywheel, an alternating current generator, or any combination thereof. The motor can be electrically coupled to an alternating current power source and can receive AC power from the power source. The flywheel can be coupled to a rotor external to the motor. The generator can be coupled to the flywheel and electrically coupled to a controller for supplying power to a load, such as an electric vehicle for charging one or more batteries of the vehicle.

### CROSS REFERENCE TO RELATED APPLICATIONS

This application claims the benefit of U.S. Provisional Patent Application No. 63/394,886, filed Aug. 3, 2022, and U.S. Provisional Patent Application No. 63/486,985, filed Feb. 25, 2023, the entire contents of which are incorporated herein by reference.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

### Field of the Invention

The present disclosure relates generally to electric vehicle charging stations and more specifically relates to high power electric vehicle charging stations.

### Description of the Related Art

Electric vehicles (EVs) are rapidly growing in number. With this rapid increase in the number of EVs, millions of chargers will need to be deployed every year. Although many of these will be low-power residential chargers that can utilize existing grid connections, many of them will be high-power direct current fast chargers (DCFC) which are currently as high as 350 kW in power draw. Some applications, such as electric trucks, may utilize a much higher power draw, such as 3 MW. These new, higher power charging requirements can place a strain on our electric grid and require an expensive, time consuming, and complicated installation process which includes bringing additional power distribution lines, sourcing large transformers, and paying expensive demand charges on peak power consumption.

As an alternative to upgrading the grid connection to support these high-power chargers, a modular energy storage system could be installed at the EV charging station site as a drop-in solution to mitigate these upgrade requirements. These modular energy storage systems could charge at low power from the existing grid connection to accumulate energy, and then discharge at high-power when the electric vehicle comes into the charging station. With this approach, power is not drawn from the grid at these higher power rates. Rather, a lower power draw from the grid charges the energy storage system over a longer time period. Then, that stored energy can be utilized to increase output power required by the high-power chargers. Thus, the grid never “sees” the high-power draw, and the cost and time to install the chargers can be reduced dramatically.

Furthermore, a modular energy storage system could be installed at the EV charging station site to avoid drawing power from the grid during peak times, or during a partial or complete power grid blackout. Many portions of our nation's power grid(s) are already at or near maximum capacity, especially during certain times of the day. Drawing more power from the grid during a peak time could cause or exacerbate an overloaded grid. Furthermore, some power companies charge more for electricity drawn during peak times. Rather than draw power from the grid at a peak time, the stored energy can be used to supply chargers during peak times or a blackout.

An electrochemical battery, such as a Li-ion battery, could be used in this application but would require alternating current (AC) to direct current (DC), or AC/DC, conversion from the grid to the battery, followed by DC/AC conversion from the battery to the DCFC because conventional DCFC are typically designed to accept AC input power from the grid. Then, the DCFC itself converts the AC back to DC for the vehicle to accept. A combined battery/DCFC system could be used, such that the grid AC is converted one time into DC. However, this could limit or eliminate the possibility of supporting existing DCFC hardware or expansions to existing DCFC installations.

Conventional flywheel energy storage systems have an added benefit of high cycle life and high power density, both of which can be important for EV charging. However, they typically involve the same complexity as the electrochemical solutions when it comes to power electronics. Because the flywheel spins at variable speed, it requires conversion from the fixed 60 Hz grid frequency to its variable frequency at the input. Furthermore, at the output, it requires conversion from a variable frequency to a fixed 60 Hz frequency that the DCFC accepts. Both steps require AC/DC/AC conversion and expensive power electronics.

### BRIEF SUMMARY OF THE INVENTION

Applicants have created new and useful devices, systems and methods for high power electric vehicle charging stations using a flywheel for energy storage. While charging stations for electric vehicles are contemplated as one possible implementation of the disclosure, the disclosed devices, systems and methods can be used with other high power charging stations.

In at least one embodiment, the power electronics can be limited or eliminated entirely. In at least one embodiment, by using a line-start synchronous motor (LSSM) at the power input, a grid-supplied AC signal can be used to excite the motor through its entire speed range, typically expressed in revolutions per minute (RPM). At lower frequencies, the LSSM can act as an induction motor, where the slip frequency results in a torque on the rotor. As the frequency of the rotor approaches the grid frequency, the motor can act as a synchronous motor with the primary interaction being between the DC field of the rotor and the AC field of the grid-supplied signal to the stator.

In at least one embodiment, the rotor can be designed such that the maximum speed matches the grid frequency. In at least one embodiment, utilization of a larger diameter rotor can be used to store sufficient energy despite the lower maximum RPM. In at least one embodiment, the rotor operation can primarily take place between 50% and 100% of maximum speed, so that the slip frequency does not have to increase too significantly and cause large inrush currents from the grid. In other words, by avoiding low rotor/flywheel RPM, the grid is not required to provide the high inrush current normally associated with an LSSM.

In at least one embodiment, the variable frequency and/or variable voltage output is connected directly to the input of the DCFC. In at least one embodiment, the frequency and/or voltage range at the rotor is configured to be within the operating range of the AC/DC converter of the DCFC, and does not fall below the threshold which would cause excessive energy accumulation between cycles on the AC/DC converter.

In at least one embodiment, power from the grid can be stored in the flywheel and/or rotor. In at least one embodiment, power from the grid can be combined with power stored in the flywheel and/or rotor at the DCFC. In at least one embodiment, power drawn from the grid is limited, with power stored in the flywheel and/or rotor being combined therewith at the DCFC in order to provide a required output power. In at least one embodiment, all of the output power can be drawn directly from the flywheel and/or rotor. In at least one embodiment, power drawn from the grid can be limited, such that the flywheel and/or rotor slows as output power is drawn therefrom. In at least one embodiment, where power drawn from the grid is limited and output power exceeds that limit, the flywheel and/or rotor can be configured to slow down or reduce speed as the output power is drawn from the system.

In at least one embodiment, a grid-connected synchronous motor can also stabilize the grid. For example, the LSSM can be designed to idle at a frequency of 60 hertz (Hz), or 3600 RPM. In at least one embodiment, if the grid frequency falls below the flywheel frequency, power can flow out from the flywheel into the grid. The flywheel “idling” frequency can be adjusted and/or selected depending on the location and the grid frequency (for example, 60 Hz is typically used in the United States and 50 Hz is typically used in the United Kingdom).

In at least one embodiment, a system for storing input power and providing output power, such as for use with electric vehicle charging, can include an alternating current motor, a flywheel, and an alternating current generator. In at least one embodiment, the motor and the generator can be the same machine. In at least one embodiment, the motor can be electrically coupled to an alternating current power source. In at least one embodiment, the motor can have a rotor and can be configured to receive AC power from the power source. In at least one embodiment, the flywheel can be mechanically coupled to the rotor external to the motor. In at least one embodiment, the generator can have a rotor mechanically coupled to the flywheel. In at least one embodiment, the generator can be configured to be electrically coupled to a controller for supplying power to a load.

In at least one embodiment, the motor can be a line start synchronous motor. In at least one embodiment, the generator can be a synchronous generator. In at least one embodiment, the load can be an electric vehicle.

In at least one embodiment, the generator can be configured to supply AC power to the controller. In at least one embodiment, the controller can be configured to convert the AC power to DC power for delivery to the load. In at least one embodiment, the motor can be configured to receive AC power from the power source at a first level. In at least one embodiment, the generator can be configured to supply AC power to the controller at one or more other levels, such as a second level higher than the first level.

In at least one embodiment, a system for storing input power and providing output power, such as for use with electric vehicle charging, can include an alternating current motor and a flywheel. In at least one embodiment, the motor can be configured to be electrically coupled to an alternating current power source. In at least one embodiment, the motor can have a rotor. In at least one embodiment, the motor can be configured to receive AC power from the power source. In at least one embodiment, the flywheel can be mechanically coupled to the rotor external to the motor. In at least one embodiment, the flywheel can be configured to mechanically store power received from the power source through the motor. In at least one embodiment, wherein the motor can be configured to be electrically coupled to a controller for supplying power to a load.

In at least one embodiment, the motor can be a line start synchronous motor. In at least one embodiment, the load can be an electric vehicle. In at least one embodiment, the motor can be configured to supply AC power to the controller. In at least one embodiment, the controller can convert the AC power to DC power for delivery to the load.

In at least one embodiment, the motor can be configured to receive AC power from the power source at a first level. In at least one embodiment, the motor can be configured to supply AC power to the controller at another level, such as a second level higher than the first level. In at least one embodiment, the motor can be configured to add power from the flywheel to the AC power received from the power source in order to supply the AC power to the controller at the second level. In at least one embodiment, the motor can be configured to limit the AC power received from the power source to the first level.

In at least one embodiment, a system for storing input power and providing output power, such as for use with electric vehicle charging, can include a controller, an alternating current motor, and a flywheel. In at least one embodiment, the controller can be configured to be electrically coupled to an alternating current power source and a load. In at least one embodiment, the controller can be configured to convert AC power to DC power for delivery to the load. In at least one embodiment, the motor can be electrically coupled to the controller. In at least one embodiment, the motor can have a rotor. In at least one embodiment, the motor can be configured to receive AC power from the power source through the controller. In at least one embodiment, the flywheel can be mechanically coupled to the rotor, such as external to or exterior of the motor. In at least one embodiment, the flywheel can be configured to mechanically store power received from the power source through the motor.

In at least one embodiment, the motor can be a line start synchronous motor. In at least one embodiment, the motor can be configured to receive AC power from the controller and supply AC power to the controller. In at least one embodiment, the load can be an electric vehicle.

In at least one embodiment, the controller can be configured to receive AC power from the power source at a first level. In at least one embodiment, the controller can be configured to supply DC power to the load at a second level, higher than the first level. In at least one embodiment, the controller can be configured to add power from the flywheel to the AC power received from the power source in order to supply the DC power to the load at the second level. In at least one embodiment, the controller can be configured to limit the AC power received from the power source to the first level.

In at least one embodiment, a system for storing input power and providing output power, such as for use with electric vehicle charging, can include a controller configured to be electrically coupled to an alternating current power source and a load, and at least one flywheel energy storage system configured to mechanically store power received from the power source. In at least one embodiment, the controller can be configured to convert AC power to DC power for delivery to the load. In at least one embodiment, each flywheel energy storage system can include a flywheel mechanically coupled to a rotor, and an alternating current motor electrically coupled to the controller and mechanically coupled to the rotor. In at least one embodiment, the motor can be configured to receive AC power from the power source. In at least one embodiment, the load can be an electric vehicle.

In at least one embodiment, the motor can be a line start synchronous reluctance motor. In at least one embodiment, the motor can be further configured to supply AC power to the controller. In at least one embodiment, the at least one flywheel energy storage system comprises a plurality of flywheel energy storage systems.

In at least one embodiment, each flywheel energy storage system can also include an alternating current generator electrically coupled to the controller and mechanically coupled to the rotor. In at least one embodiment, the generator can be configured to supply AC power to the controller. In at least one embodiment, the alternating current generator can be a synchronous alternating current generator.

In at least one embodiment, the rotor can be supported by at least one high temperature superconducting magnetic bearing. For example, the rotor can be axially supported at an upper end by one high temperature superconducting magnetic bearing and/or at a lower end by another high temperature superconducting magnetic bearing. In at least one embodiment, the flywheel can be supported by at least one magnetic levitation bearing. For example, the flywheel can be supported from below by a repulsion mode permanent magnet levitation bearing and/or from above by an attraction mode permanent magnet levitation bearing.

In at least one embodiment, the controller can be configured to receive AC power from the power source at a first level and supply DC power to the load at a second level. In at least one embodiment, the second level can be higher than the first level. In at least one embodiment, the controller can be configured to add power from the flywheel to the AC power received from the power source in order to supply the DC power to the load at the second level. In at least one embodiment, the controller can be configured to limit the AC power received from the power source to one or more levels, such as the first level.

In at least one embodiment, a system for storing input power and providing output power, such as for use with electric vehicle charging, can include a controller, a line start synchronous alternating current motor, a flywheel, a synchronous alternating current generator, or any combination thereof. In at least one embodiment, the controller can be electrically coupled to an alternating current power source and/or a load. In at least one embodiment, the controller can convert AC power to DC power for delivery to the load at a first level.

In at least one embodiment, the line start synchronous alternating current motor can be electrically coupled to the alternating current power source. In at least one embodiment, the motor can have a first rotor and/or can receive AC power from the power source at a second level. In at least one embodiment, the second level can be lower than the first level. In at least one embodiment, the controller can limit the AC power received from the power source to the second level. In at least one embodiment, the flywheel can be mechanically coupled to the first rotor external to the motor.

In at least one embodiment, the synchronous alternating current generator can have a second rotor mechanically coupled to the flywheel. In at least one embodiment, the generator can be electrically coupled to the controller for supplying power to the load. In at least one embodiment, the load can be an electric vehicle. In at least one embodiment, the generator can supply AC power to the controller.

### BRIEF DESCRIPTION OF THE SEVERAL VIEWS OF THE DRAWINGS

FIG. 1 is a block diagram of one of many embodiments of a system for storing input power and providing output power according to the disclosure.

FIG. 2 is a block diagram of the system for storing input power and providing output power of FIG. 1, showing power flow.

FIG. 3 is a block diagram of another of many embodiments of a system for storing input power and providing output power according to the disclosure.

FIG. 4 is a block diagram of the system for storing input power and providing output power of FIG. 3, showing power flow during a charge period.

FIG. 5 is a block diagram of the system for storing input power and providing output power of FIG. 3, showing one possible power flow during a discharge period.

FIG. 6 is a block diagram of the system for storing input power and providing output power of FIG. 3, showing another possible power flow during a discharge period.

FIG. 7 is a block diagram of still another of many embodiments of a system for storing input power and providing output power according to the disclosure.

FIG. 8 is a block diagram of the system for storing input power and providing output power of FIG. 7, showing power flow during a charge period.

FIG. 9 is a block diagram of the system for storing input power and providing output power of FIG. 7, showing one possible power flow during a discharge period.

FIG. 10 is a block diagram of the system for storing input power and providing output power of FIG. 7, showing another possible power flow during a discharge period.

FIG. 11 is a block diagram of select components of one of many embodiments of a system for storing input power and providing output power according to the disclosure.

FIG. 12 is a block diagram of select components of another of many embodiments of a system for storing input power and providing output power according to the disclosure.

FIG. 13 is a block diagram of still another of many embodiments of a system for storing input power and providing output power according to the disclosure.

FIG. 14 is a block diagram of select components of another one of many embodiments of a system for storing input power and providing output power according to the disclosure.

### DETAILED DESCRIPTION OF THE INVENTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms.

The use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the inventions or the appended claims. The terms “including” and “such as” are illustrative and not limitative. The terms “couple,” “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and can further include without limitation integrally forming one functional member with another in a unity fashion. The coupling can occur in any direction, including rotationally. Further, all parts and components of the disclosure that are capable of being physically embodied inherently include imaginary and real characteristics regardless of whether such characteristics are expressly described herein, including but not limited to characteristics such as axes, ends, inner and outer surfaces, interior spaces, tops, bottoms, sides, boundaries, dimensions (e.g., height, length, width, thickness), mass, weight, volume and density, among others.

Process flowcharts discussed herein illustrate the operation of possible implementations of systems, methods, and computer program products according to various embodiments of the present invention. In this regard, each block in the flowchart may represent a module, segment, or portion of code, which can include one or more executable instructions for implementing the specified logical function(s). It should also be noted that, in some implementations, the functions noted in the blocks might occur out of the order depicted in the figures. For example, blocks shown in succession may, in fact, be executed substantially concurrently. It will also be noted that one or more blocks of a flowchart illustration can be implemented by special purpose hardware-based systems that perform the specified functions or acts, or combinations of special purpose hardware and computer instructions.

Applicants have created new and useful devices, systems and methods for high power electric vehicle charging stations using a flywheel for energy storage. While charging stations for electric vehicles are contemplated, the disclosed devices, systems and methods can be used with other high power charging stations. In at least one embodiment, a system according to the disclosure, such as an energy storage system or a system for storing input power and providing output power, can include one or more controllers for converting AC power to DC power for delivery to a load, and one or more flywheel energy storage systems for mechanically storing power received from a power source. In at least one embodiment, a flywheel energy storage system according to the disclosure can include one or more flywheels mechanically coupled to one or more rotors, and one or more alternating current motors, such as a line-start synchronous motor, for receiving AC power from a power source.

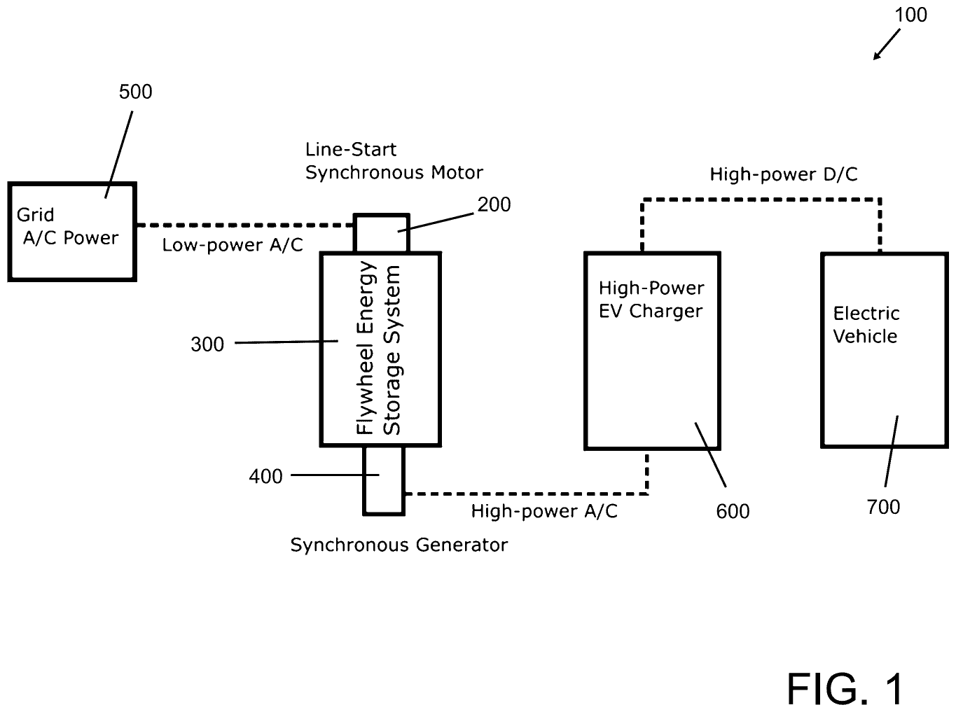

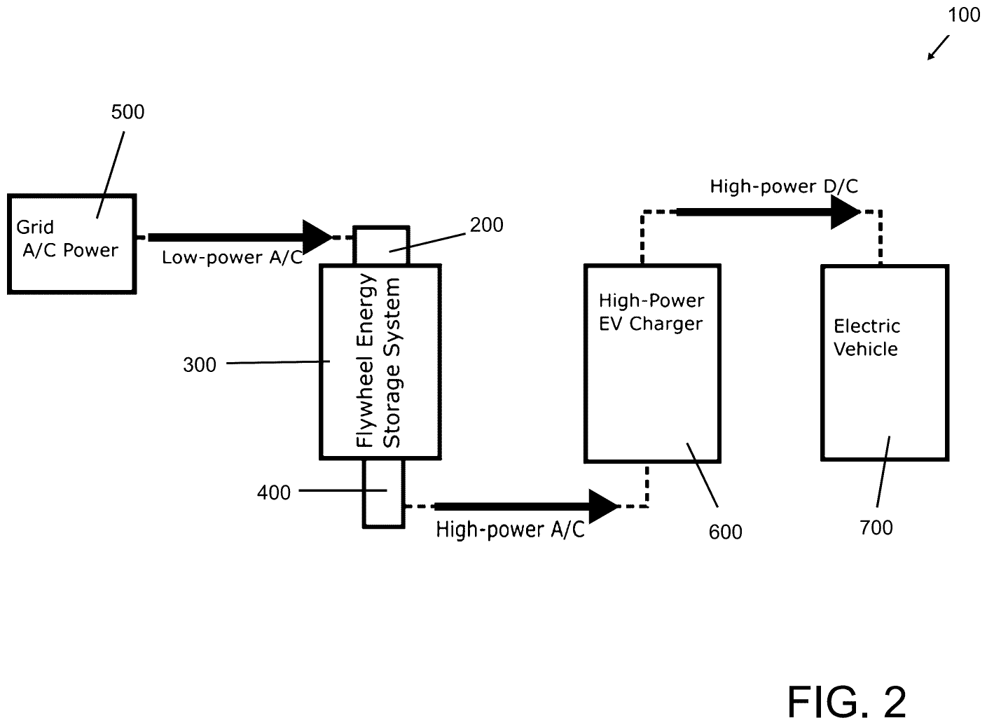

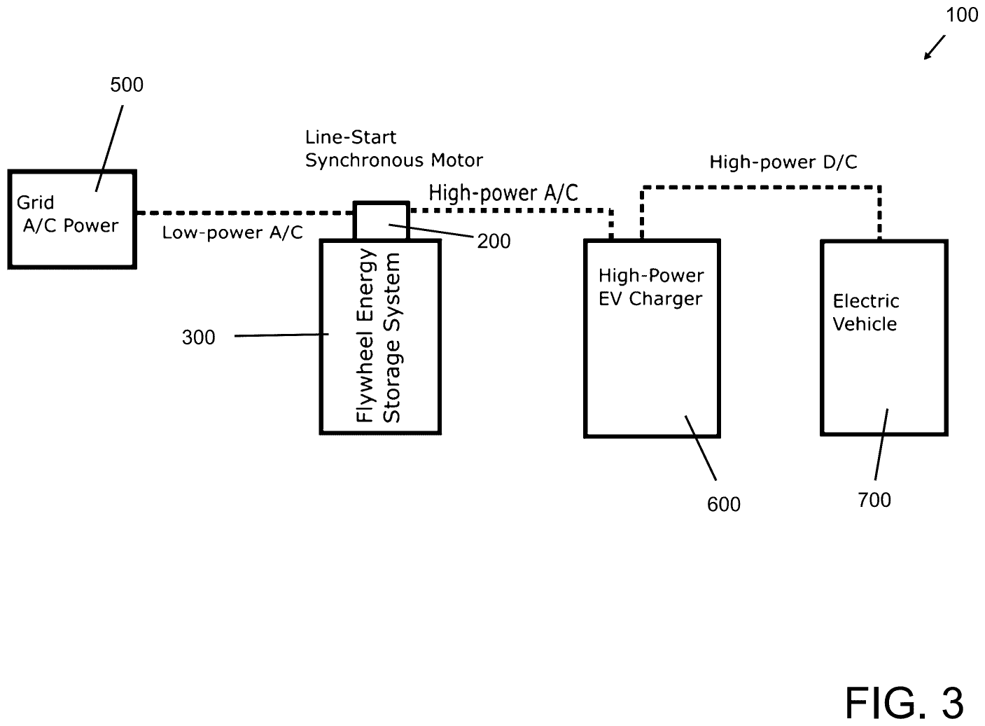

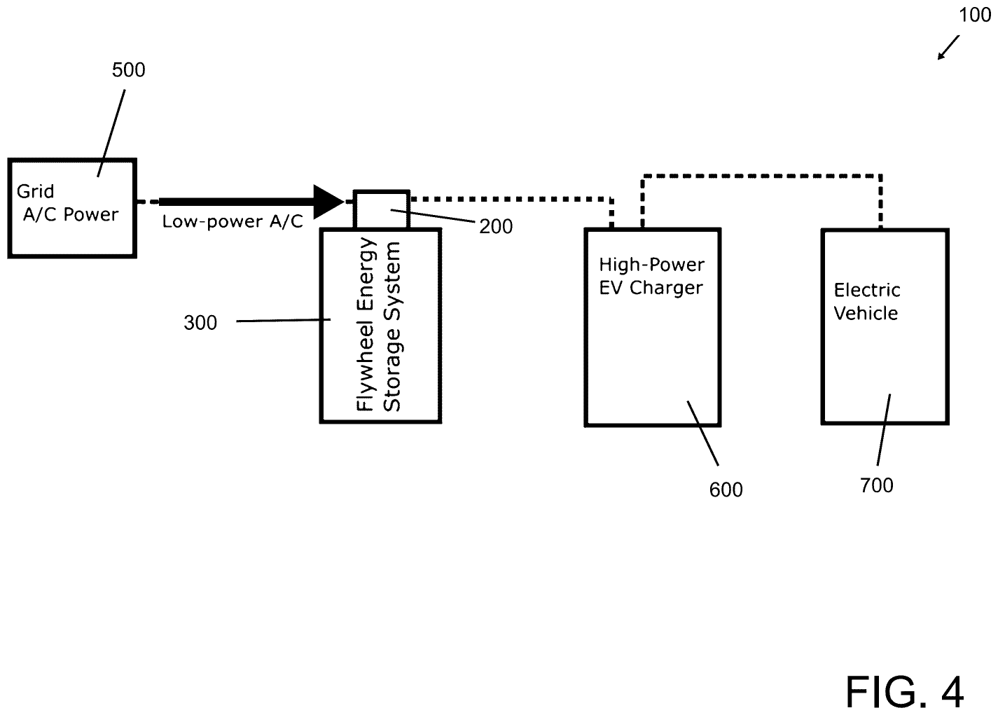

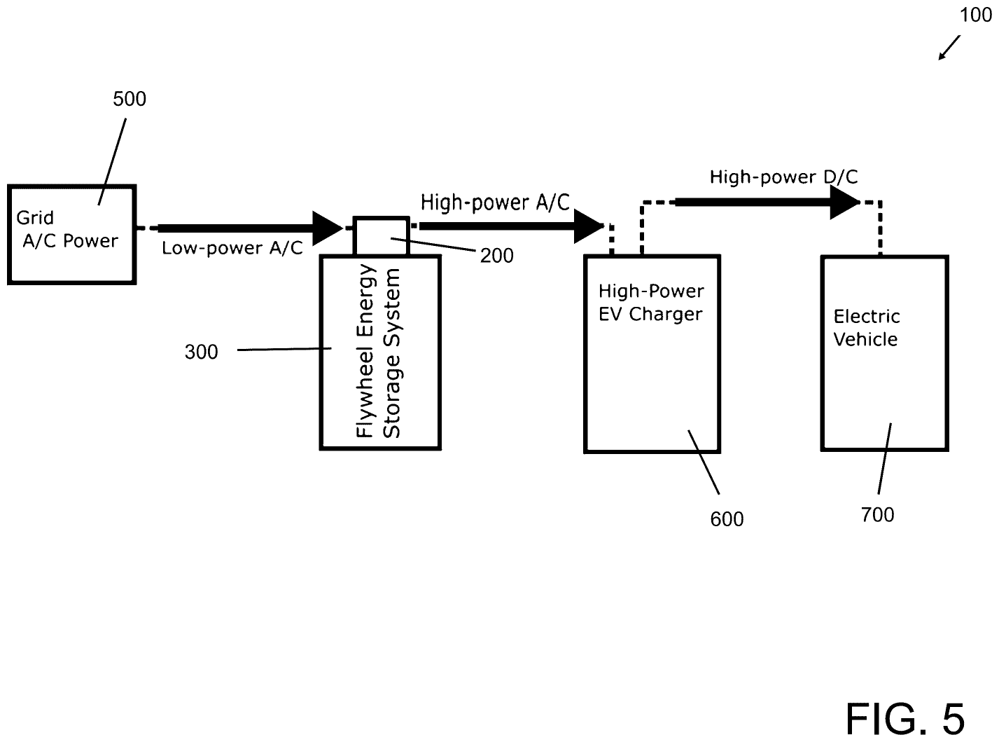

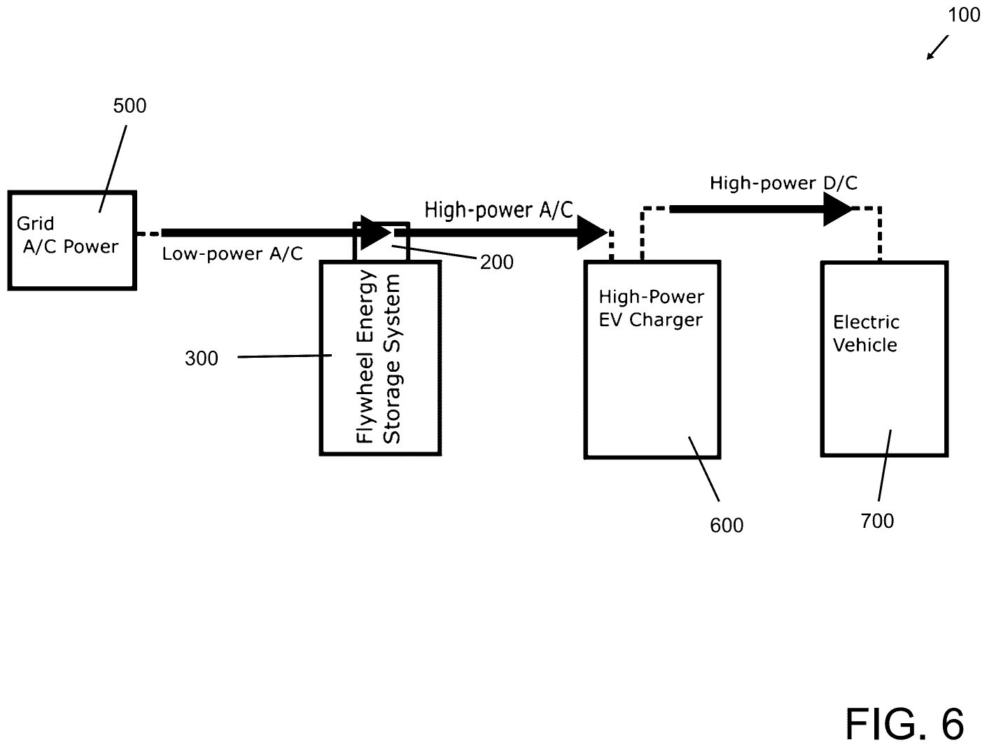

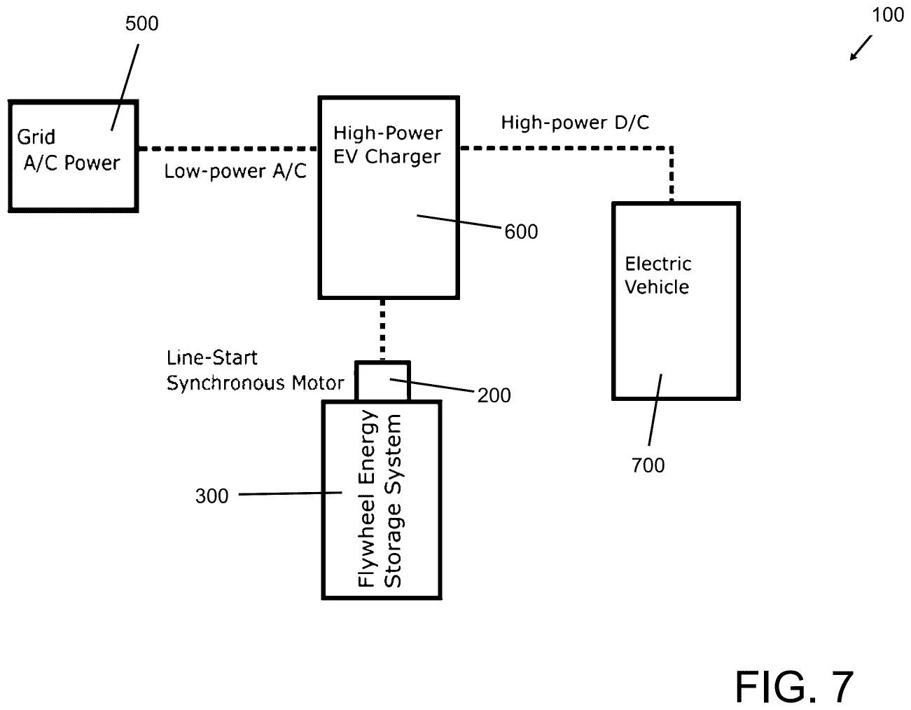

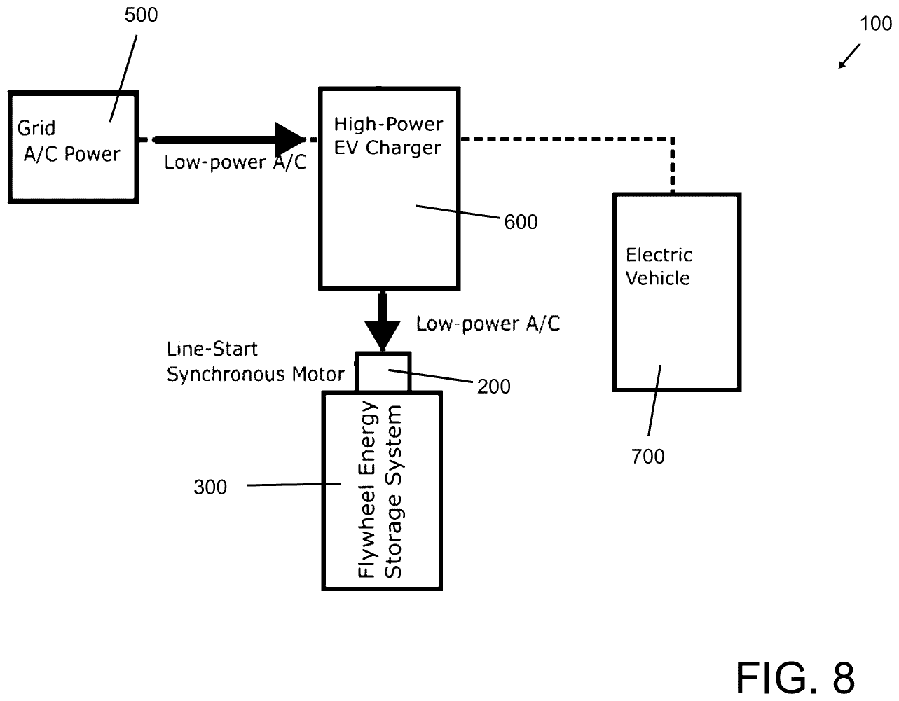

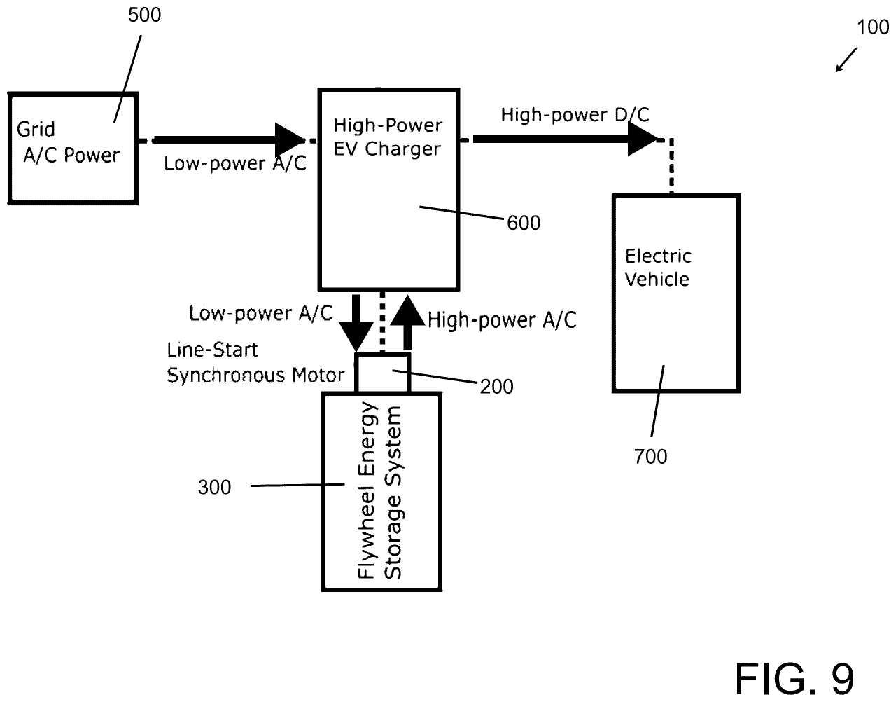

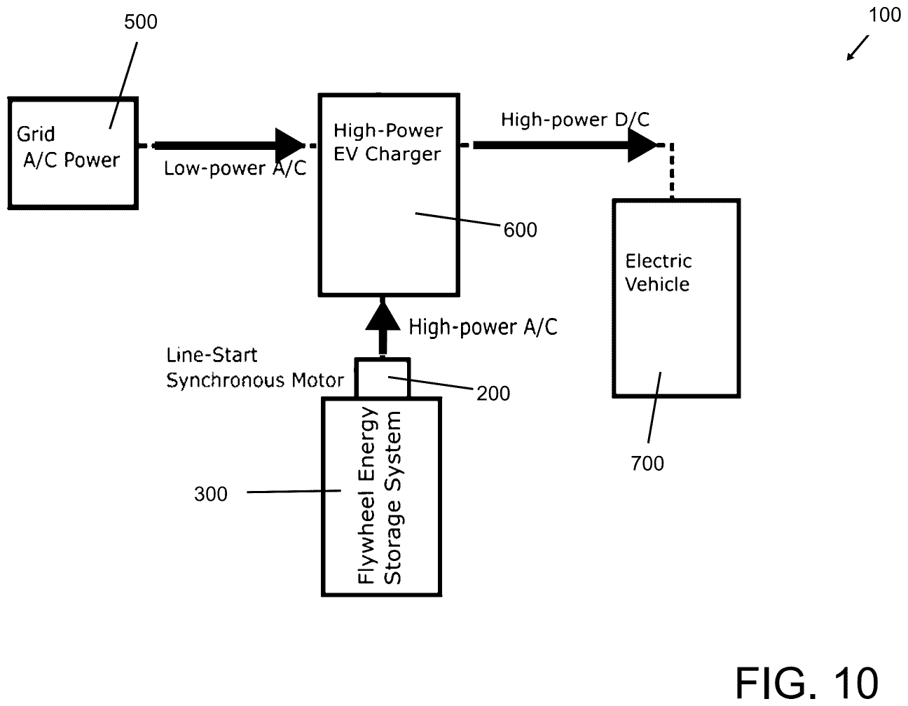

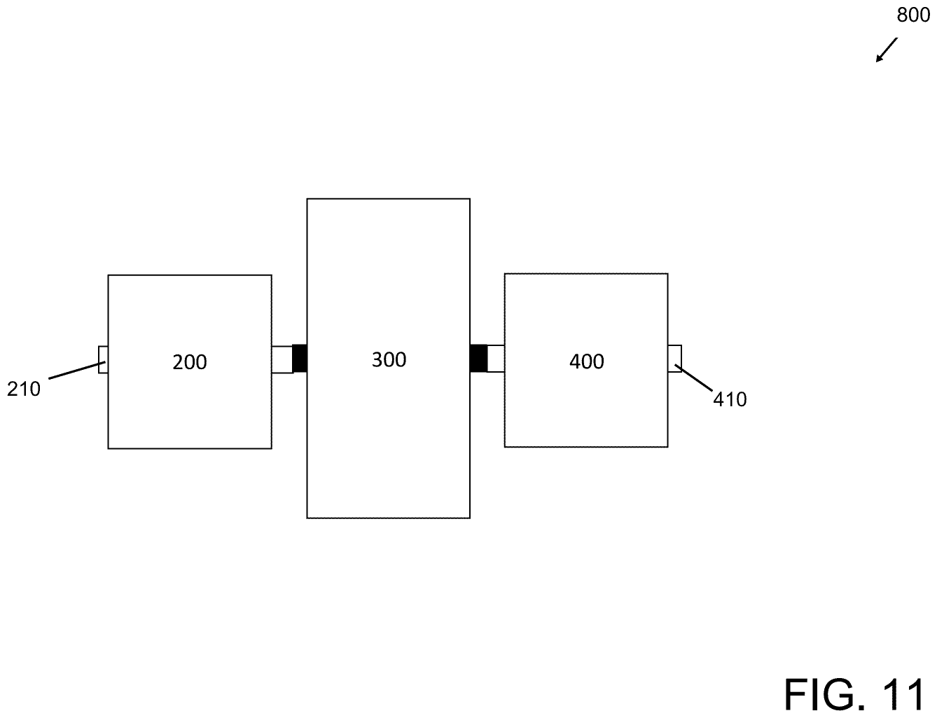

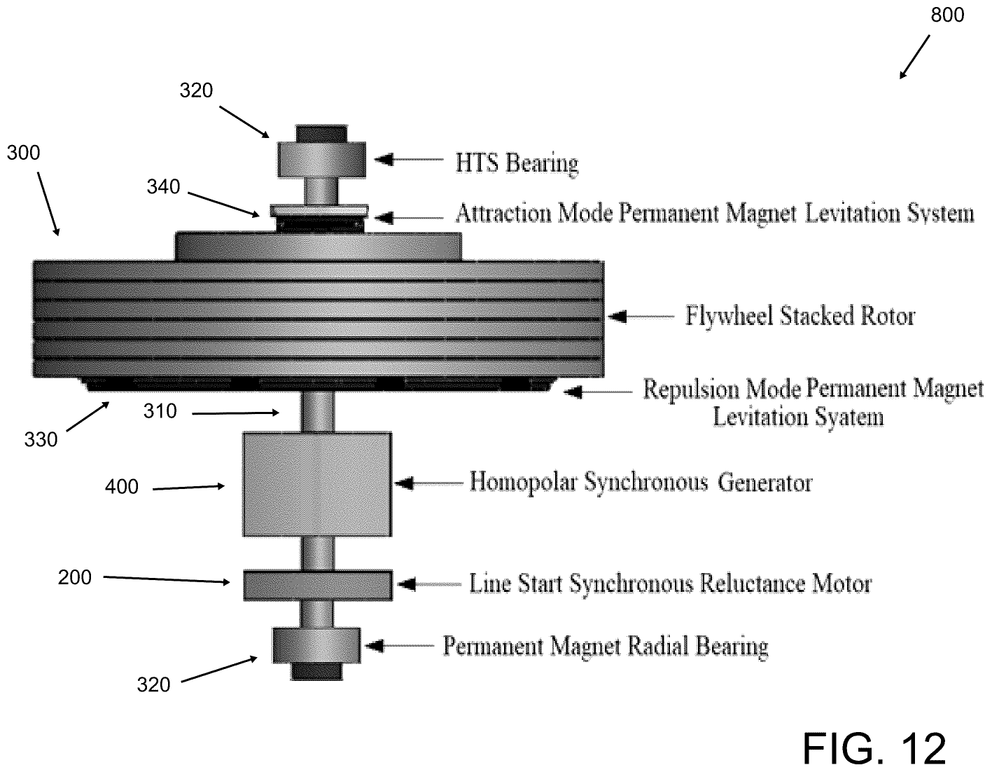

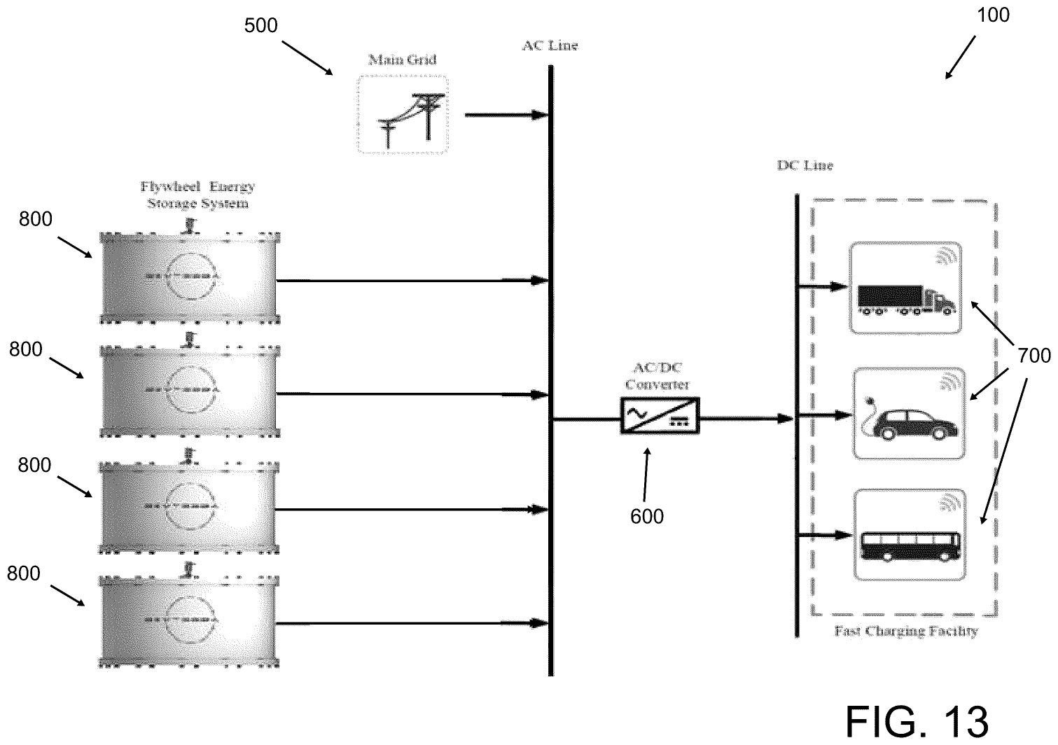

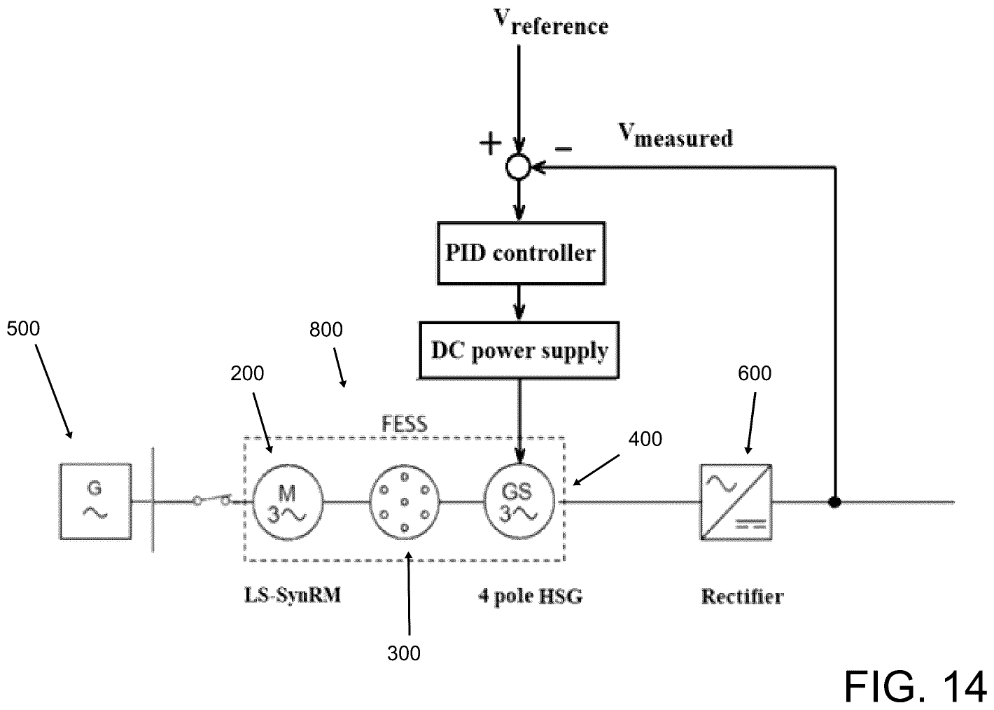

FIG. 1 is a block diagram of one of many embodiments of a system for storing input power and providing output power according to the disclosure. FIG. 2 is a block diagram of the system for storing input power and providing output power of FIG. 1, showing power flow. FIG. 3 is a block diagram of another of many embodiments of a system for storing input power and providing output power according to the disclosure. FIG. 4 is a block diagram of the system for storing input power and providing output power of FIG. 3, showing power flow during a charge period. FIG. 5 is a block diagram of the system for storing input power and providing output power of FIG. 3, showing one possible power flow during a discharge period. FIG. 6 is a block diagram of the system for storing input power and providing output power of FIG. 3, showing another possible power flow during a discharge period. FIG. 7 is a block diagram of still another of many embodiments of a system for storing input power and providing output power according to the disclosure. FIG. 8 is a block diagram of the system for storing input power and providing output power of FIG. 7, showing power flow during a charge period. FIG. 9 is a block diagram of the system for storing input power and providing output power of FIG. 7, showing one possible power flow during a discharge period. FIG. 10 is a block diagram of the system for storing input power and providing output power of FIG. 7, showing another possible power flow during a discharge period. FIG. 11 is a block diagram of select components of one of many embodiments of a system for storing input power and providing output power according to the disclosure. FIG. 12 is a block diagram of select components of another of many embodiments of a system for storing input power and providing output power according to the disclosure. FIG. 13 is a block diagram of still another of many embodiments of a system for storing input power and providing output power according to the disclosure. FIG. 14 is a block diagram of select components of another one of many embodiments of a system for storing input power and providing output power according to the disclosure. FIGS. 1-14 are described in conjunction with one another.

In at least one embodiment, a system 100 according to the disclosure, such as an energy storage system or a system for storing input power and providing output power, can include one or more alternating current motors 200, one or more flywheels 300, one or more alternating current generators 400, or any combination thereof. In at least one embodiment, motor 200 and generator 400 can be the same machine. In at least one embodiment, motor 200 can be electrically coupled to one or more alternating current power sources 500, such as a conventional power grid. In at least one embodiment, motor 200 can have one or more rotors 210 and/or can be configured to receive AC power from power source 500. In at least one embodiment, flywheel 300 can be mechanically coupled to rotor 210 external to motor 200. In at least one embodiment, generator 400 can have one or more rotors 410 mechanically coupled to flywheel 300. In at least one embodiment, generator 400 can be configured to be electrically coupled to one or more controllers 600 for supplying power to one or more loads 700.

In at least one embodiment, motor 200 can be a line start synchronous motor. In at least one embodiment, motor 200 can be a three phase two pole line start synchronous reluctance motor. In at least one embodiment, generator 400 can be a synchronous generator. In at least one embodiment, generator 400 can be a three phase four pole homopolar synchronous machine. In at least one embodiment, load 700 can be an electric vehicle, such as a passenger vehicle, a bus, or a commercial transportation vehicle.

In at least one embodiment, generator 400 can be configured to supply AC power to controller 600. In at least one embodiment, controller 600 can be configured to convert the AC power to DC power for delivery to load 700. In at least one embodiment, motor 200 can be configured to receive AC power from power source 500 at a first level. In at least one embodiment, generator 400 can be configured to supply AC power to controller 600 at a second level, higher than the first level.

In at least one embodiment, generator 400 can be configured to supply AC power at the same voltage and frequency as that received by motor 200 from grid 500. In at least one embodiment, generator 400 can be configured to supply AC power at a different voltage and/or a different frequency as that received by motor 200 from grid 500. For example, motor 200 and/or generator 400 can be mechanically coupled to flywheel 300 through one or more gear systems, thus providing a gear ratio, and thus a different voltage and/or a different frequency.

When the output power supplied to controller 600 is of higher magnitude than the input power received from grid 500, flywheel 300 may slow down. In this manner, flywheel 300 can supply some of the power supplied by controller 600. In at least one embodiment, if flywheel 300 is completely depleted, the flywheel 300 can come to a complete stop. Restarting flywheel 300 from a complete stop and/or slow speeds can cause a large inrush current. Thus, flywheel 300 and/or other components of system 100 can be designed to supply the necessary power to charge load 700 before flywheel 300 is completely depleted. In at least one embodiment, flywheel 300 is not depleted more than 50%. In at least one embodiment, flywheel 300 is not depleted more than 75%. In at least one embodiment, flywheel 300 is not depleted more than 90%.

In at least one embodiment, flywheel 300 can be ‘charged’ by spinning it up to its maximum design RPM while system 100 is not being used to charge load 700. In at least one embodiment, when system 100 is being used to charge load 700, energy stored in flywheel 300 can supply some or all of the power necessary to charge load 700. At least because flywheel 300 can be designed to store a large amount of energy, system 100 can supply more power to load 700 than it ever receives at any one time. In other words, system 100 can draw power from grid 500 at a lower rate and/or over a longer period of time and can deliver that power to load 700 at a higher rate and/or over a shorter period of time.

One or more of the features described herein can be particularly useful where there is a maximum power level that can be drawn from grid 500, without upgrading equipment and/or paying higher fees, and supplying load 700 at a higher rate is desired. One or more of these features can also be used to purchase and store power from grid 500 during off-peak times, when the power might be cheaper or otherwise preferred, and to supply power to load 700 whenever needed, which can include, for example, peak times or when grid 500 is experiencing brownouts or blackouts.

In at least one embodiment, a system 100 for storing input power and providing output power according to the disclosure, such as for use with electric vehicle charging, can include one or more alternating current motors 200 and/or one or more flywheels 300. In at least one embodiment, motor 200 can be configured to be electrically coupled to one or more alternating current power sources 500. In at least one embodiment, motor 200 can have one or more rotors 210. In at least one embodiment, motor 200 can be configured to receive AC power from power source 500. In at least one embodiment, flywheel 300 can be mechanically coupled to rotor 210 external to motor 200. In at least one embodiment, flywheel 300 can be configured to mechanically store power received from power source 500 through motor 200. In at least one embodiment, motor 200 can be configured to be electrically coupled to one or more controllers 600 for supplying power to one or more loads 700.

In at least one embodiment, motor 200 can be a line start synchronous motor. In at least one embodiment, motor 200 can be a three phase two pole line start synchronous reluctance motor. In at least one embodiment, load 700 can be one or more electric vehicles (or a power source thereof, such as a battery or battery bank), such as a passenger vehicle, a bus, a commercial transportation vehicle, or any combination thereof. In at least one embodiment, motor 200 can be configured to supply AC power to controller 600. In at least one embodiment, controller 600 can convert the AC power to DC power for delivery to load 700.

In at least one embodiment, motor 200 can be configured to receive AC power from power source 500 at one or more levels, such as a first level. In at least one embodiment, motor 200 can be configured to supply AC power to controller 600 at one or more levels, such as a second level higher than the first level. In at least one embodiment, motor 200 can be configured to add power from flywheel 300 to the AC power received from power source 500 in order to supply the AC power to controller 600 at the second level. In at least one embodiment, motor 200 can be configured to limit the AC power received from power source 500 to the first level.

In at least one embodiment, controller 600, or portions thereof, can be integrated into motor 200. For example, controller 600, or portions thereof, can by integral to motor 200. In at least one embodiment, motor 200 can include one or more current control and/or limiting devices. In at least one embodiment, such devices can be controlled by controller 600. In this manner, motor 200, controller 600, or both can be configured to limit the AC power received from power source 500 to the first level.

In at least one embodiment, motor 200 can be configured to convert electrical energy received from grid 500 into mechanical energy sent to flywheel 300, regardless of whether system 100 is being used to supply power to load 700. In this manner, AC power received from power source 500 can be used to reduce the slowing of flywheel 300 when system 100 is being used to supply power to load 700.

In at least one embodiment, motor 200 can be configured to combine electrical energy received from grid 500 with mechanical energy from flywheel 300, when system 100 is being used to supply power to load 700. In this manner, AC power received from power source 500 can be used to supplement power depleted from flywheel 300, and thereby reduce the slowing of flywheel 300 when system 100 is being used to supply power to load 700.

In at least one embodiment, a system 100 for storing input power and providing output power according to the disclosure, such as for use with electric vehicle charging, can include one or more controllers 600, one or more alternating current motors 200, one or more flywheels 300, or any combination thereof. In at least one embodiment, controller 600 can be configured to be electrically coupled to one or more alternating current power source 500, one or more loads 700, or any combination thereof. In at least one embodiment, controller 600 can be configured to convert AC power to DC power for delivery to load 700. In at least one embodiment, motor 200 can be electrically coupled to controller 600. In at least one embodiment, motor 200 can have one or more rotors 210. In at least one embodiment, motor 200 can be configured to receive AC power from power source 500 through controller 600. In at least one embodiment, flywheel 300 can be mechanically coupled to rotor 210 external to motor 200. In at least one embodiment, flywheel 300 can be configured to mechanically store power received from power source 500 through motor 200.

In at least one embodiment, motor 200 can be a line start synchronous motor. In at least one embodiment, motor 200 can be a three phase two pole line start synchronous reluctance motor. In at least one embodiment, load 700 can be one or more electric vehicles, such as one or more passenger vehicles, one or more buses, one or more commercial transportation vehicles, or any combination thereof.

In at least one embodiment, controller 600 can be configured to receive AC power from power source 500 at a first level. In at least one embodiment, controller 600 can be configured to supply DC power to load 700 at a second level, higher than the first level. In at least one embodiment, controller 600 can be configured to add power from flywheel 300 to the AC power received from power source 500 in order to supply the DC power to load 700 at the second level. In at least one embodiment, controller 600 can be configured to limit the AC power received from power source 700 to the first level. In at least one embodiment, controller 600 can include one or more current control and/or limiting devices for controlling motor 200. In this manner, motor 200, controller 600, or both can be configured to limit the AC power received from power source 500 to the first level.

In at least one embodiment, controller 600 can be configured to feed the electrical energy received from grid 500 to motor 200 where it can be converted into mechanical energy sent to flywheel 300, regardless of whether system 100 is being used to supply power to load 700. In this manner, AC power received from power source 500 can be used to reduce the slowing of flywheel 300 when system 100 is being used to supply power to load 700.

In at least one embodiment, controller 600 can be configured to combine the electrical energy received from grid 500 with the electrical energy received from flywheel 300 through motor 200, when system 100 is being used to supply power to load 700. In this manner, AC power received from power source 500 can be used to supplement power depleted from flywheel 300, and thereby reduce the slowing of flywheel 300 when system 100 is being used to supply power to load 700.

In at least one embodiment, a system 100 for storing input power and providing output power according to the disclosure, such as for use with electric vehicle charging, can include one or more controllers 600 configured to be electrically coupled to one or more alternating current power sources 500 and/or one or more loads 700, one or more flywheel energy storage systems 800 configured to mechanically store power received from power source 500, or any combination thereof. In at least one embodiment, controller 600 can be configured to convert AC power to DC power for delivery to load 700. In at least one embodiment, any or all flywheel energy storage systems 800 can include one or more flywheels 300 mechanically coupled to one or more rotors 310, one or more alternating current motors 200 electrically coupled to controller 600 and/or mechanically coupled to rotor 310, or any combination thereof. In at least one embodiment, motor 200 can be configured to receive AC power from power source 500. In at least one embodiment, load 700 can be one or more electric vehicles.

In at least one embodiment, flywheel energy storage system 800 can include a plurality of flywheel energy storage systems 800. In at least one embodiment, system 100 can include two, three, four, or more flywheel energy storage systems 800, thereby providing scalability to system 100. For example, a system 100 according to the disclosure configured to charge passenger vehicles can include one or two flywheel energy storage systems 800. As another example, a system 100 according to the disclosure configured to charge passenger vehicles and larger vehicles, can include two, three, or more flywheel energy storage systems 800. As another example, a system 100 configured to charge passenger vehicles and/or larger vehicles during a blackout, or a peak time, can include four or more flywheel energy storage systems 800, thereby minimizing or eliminating any power drawn from the grid during a blackout or a peak time.

In at least one embodiment, motor 200 can be a line start synchronous motor. In at least one embodiment, motor 200 can be a three phase two pole line start synchronous reluctance motor. In at least one embodiment, motor 200 can be further configured to supply AC power to controller 600. In at least one embodiment, motor 200 can be a connected directly to grid 500 without any power electronic interfaces, such as variable frequency drives. In at least one embodiment, motor 200 can be connected directly to grid 500 via one or more breakers, such as a molded case circuit breaker (MCCB).

In at least one embodiment, flywheel energy storage system 800 can also include one or more alternating current generators 400 electrically coupled to controller 600 and mechanically coupled to rotor 310. In at least one embodiment, generator 600 can be configured to supply AC power to controller 600. In at least one embodiment, alternating current generator 600 can be a synchronous alternating current generator. In at least one embodiment, alternating current generator 600 can be a three phase four pole homopolar synchronous machine.

In at least one embodiment, rotor 310 can be supported by one or more high temperature superconducting magnetic bearings 320. For example, rotor 310 can be axially supported at an upper end by one or more high temperature superconducting magnetic bearings 320 and/or at a lower end by one or more other high temperature superconducting magnetic bearings 320. In at least one embodiment, flywheel 300 can be supported by one or more magnetic levitation bearings 330, 340. For example, flywheel 300 can be supported from below by one or more repulsion mode permanent magnet levitation bearings 330 and/or from above by one or more attraction mode permanent magnet levitation bearings 340.

In at least one embodiment, rotor 310 can be common to motor 200, flywheel 300, generator 400, or any combination thereof. For example, in at least one embodiment, motor 200 can have its own rotor 210, which can be mechanically coupled with rotor 310 of flywheel 300. Similarly, in at least one embodiment, generator 400 can have its own rotor 410, which can be mechanically coupled with rotor 310 of flywheel 300. In at least one embodiment, flywheel 300 can be configured to rotate about any of rotors 210, 310, 410 in a horizontal plane. In at least one embodiment, flywheel 300 can be configured to rotate about any of rotors 210, 310, 410 in a vertical plane.

In at least one embodiment, flywheel 300 can be positioned between motor 200 and generator 400. In at least one embodiment, motor 200 can be positioned between flywheel 300 and generator 400. In at least one embodiment, generator 400 can be positioned between motor 200 and flywheel 300.

In at least one embodiment, controller 600 can be configured to receive AC power from power source 500 at a first level and supply DC power to load 700 at a second level. In at least one embodiment, the second level can be higher than the first level. In at least one embodiment, controller 600 can be configured to add power from flywheel 300 to the AC power received from power source 500 in order to supply the DC power to load 700 at the second level. In at least one embodiment, controller 600 can be configured to limit the AC power received from power source 500 to the first level. In at least one embodiment, controller 600 can include one or more rectifiers. In at least one embodiment, controller 600 can include one or more adjustable rectifiers and can thereby adjust the output voltage of the DC power supplied to load 700. In at least one embodiment, controller 600 can control one or more separate adjustable rectifiers and can thereby adjust the output voltage of the DC power supplied to load 700.

In at least one embodiment, generator 400 can be a homopolar generator that is magnetized through a stationary DC field winding secured to the stator. In at least one embodiment, a proportional integral derivative (PID) control system can adjust the field current to achieve a desired output voltage, which can be different for different loads, such as a passenger car, a bus, or a commercial transportation vehicle, and which can be or include any output voltage required or desired according to an implementation of the disclosure. In at least one embodiment, a desired output voltage can be specified by load 700, a user, controller 600, or any combination thereof. For example, controller 600 can detect which type of load 700 is connected thereto and can set a reference voltage for the PID control system accordingly. In at least one embodiment, the PID control system can be integral to controller 600. In at least one embodiment, the PID control system can be independent from controller 600.

In at least one embodiment, system 100 can include one or more flywheels 300, bearings 320, 330, 340 and/or other components disclosed in any of U.S. patent application Ser. No. 17/348,716 filed Jun. 15, 2021; U.S. Pat. No. 11,105,368 dated Aug. 31, 2021; U.S. Pat. No. 10,077,805 dated Sep. 18, 2018; U.S. Pat. No. 9,404,532 dated Aug. 2, 2016; and/or U.S. Provisional Application No. 61/884,766 filed Jul. 10, 2013; the entire contents of which are incorporated herein by reference.

In at least one embodiment, a system 100 for storing input power and providing output power according to the disclosure, such as for use with electric vehicle charging, can provide an adjustable output voltage for various vehicles without any DC/DC converters, which can be subject to high failure rates. For example, controller 600 can be configured to charge various vehicles, each with different charging rates and/or voltages, without a DC/DC converter.

In at least one embodiment, a system 100 according to the disclosure can provide stable voltage and power rating during charging, regardless of the capacity and fluctuations in power grid 500. In at least one embodiment, a system 100 according to the disclosure can provide very fast charging due to very high power being accessible, regardless of the capacity and fluctuations in power grid 500. In at least one embodiment, a system 100 according to the disclosure can provide scalability according to the desired charging station ratings, which can be or include any ratings according to an implementation of the disclosure.

In at least one embodiment, a system 100 according to the disclosure can operate without grid connection interfaces, such as variable frequency drives, or unreliable load interfaces. For example, commonly available DC/DC chargers can have high failure rates. Additionally, system 100, which can be configured without any DC/DC chargers, can be more reliable, have a simpler structure, lower installation costs, and lower maintenance requirements.

In at least one embodiment, a flywheel energy storage system 800 according to the disclosure can have negligible idling losses and long expected life, especially when compared to alternative energy storage systems. For example, flywheel energy storage system 800 can be configured to avoid voltage drops that would normally be associated with battery systems.

In at least one embodiment, a system 100 for storing input power and providing output power according to the disclosure, such as for use with electric vehicle charging, can include one or more controllers 600, one or more line start synchronous alternating current motors 200, one or more flywheels 300, one or more synchronous alternating current generators 400, or any combination thereof. In at least one embodiment, controller 600 can be electrically coupled to one or more alternating current power sources 500 and/or one or more loads 700. In at least one embodiment, controller 600 can convert AC power to DC power for delivery to load 700 at a first level.

In at least one embodiment, motor 200 can be electrically coupled to source 500. In at least one embodiment, motor 200 can have one or more rotors 210 and/or can receive AC power from the source 500 at a second level. In at least one embodiment, the second level can be lower than the first level. In at least one embodiment, controller 600 can limit the AC power received from the source 500 to the second level. In at least one embodiment, flywheel 300 can be mechanically coupled to rotor 210 external to motor 200.

In at least one embodiment, generator 400 can have one or more rotors 410 mechanically coupled to flywheel 300. In at least one embodiment, generator 400 can be electrically coupled to controller 600 for supplying power to load 700. In at least one embodiment, load 700 can be one or more electric vehicles. In at least one embodiment, generator can supply AC power to controller 600.

In at least one embodiment, power electronics can be limited or eliminated entirely. In at least one embodiment, by using a line-start synchronous motor (LSSM) at the power input, the grid-supplied AC signal can be used to excite the motor through its entire speed range, typically expressed in revolutions per minute (RPM). At lower frequencies, the LSSM acts as an induction motor, where the slip frequency results in a torque on the rotor. As the frequency of the rotor approaches the grid frequency, the motor acts as a synchronous motor with the primary interaction being between the DC field of the rotor and the AC field of the grid-supplied signal to the stator.

In at least one embodiment, the rotor can be designed such that the maximum speed matches the grid frequency. In at least one embodiment, utilization of a larger diameter rotor can be used to store sufficient energy despite the lower maximum RPM. In at least one embodiment, the rotor operation can primarily take place between 50% and 100% of maximum speed, so that the slip frequency does not have to increase too significantly and cause large inrush currents from the grid. In other words, by avoiding low rotor/flywheel RPM, the grid is not required to provide the high inrush current normally associated with a LSSM.

In at least one embodiment, the variable frequency and/or variable voltage output is connected directly to the input of the DCFC. In at least one embodiment, the frequency and/or voltage range at the rotor is configured to be within the operating range of the AC/DC converter of the DCFC, and does not fall below the threshold which would cause excessive energy accumulation between cycles on the AC/DC converter.

In at least one embodiment, power from the grid is stored in the flywheel and/or rotor. In at least one embodiment, power from the grid is combined with power stored in the flywheel and/or rotor at the DCFC. In at least one embodiment, power drawn from the grid is limited, with power stored in the flywheel and/or rotor being combined therewith at the DCFC in order to provide a required output power. In at least one embodiment, all of the output power is drawn directly from the flywheel and/or rotor. In at least one embodiment, power drawn from the grid is limited, such that the flywheel and/or rotor slows as output power is drawn therefrom. In at least one embodiment, where power drawn from the grid is limited and output power exceeds that limit, the flywheel and/or rotor slows as the output power is drawn from the system.

In at least one embodiment, the grid-connected synchronous motor can also stabilize the grid. For example, the LSSM can be designed to idle at a frequency of 60 hertz (Hz), or 3600 RPM. In at least one embodiment, if the grid frequency falls below the flywheel frequency, power can flow out from the flywheel into the grid. The flywheel “idling” frequency can be adjusted and/or selected depending on the location and the grid frequency (for example, 60 Hz is typically used in the United States and 50 Hz is typically used in the United Kingdom).

In at least one embodiment, a system for storing input power and providing output power, such as for use with electric vehicle charging, can include an alternating current motor, a flywheel, and an alternating current generator. In at least one embodiment, the motor and the generator can be the same machine. In at least one embodiment, the motor can be electrically coupled to an alternating current power source. In at least one embodiment, the motor can have a rotor and can be configured to receive AC power from the power source. In at least one embodiment, the flywheel can be mechanically coupled to the rotor external to the motor. In at least one embodiment, the generator can have a rotor mechanically coupled to the flywheel. In at least one embodiment, the generator can be configured to be electrically coupled to a controller for supplying power to a load.

In at least one embodiment, the motor can be a line start synchronous motor. In at least one embodiment, the generator can be a synchronous generator. In at least one embodiment, the load can be an electric vehicle.

In at least one embodiment, the generator can be configured to supply AC power to the controller. In at least one embodiment, the controller can be configured to convert the AC power to DC power for delivery to the load. In at least one embodiment, the motor can be configured to receive AC power from the power source at a first level. In at least one embodiment, the generator can be configured to supply AC power to the controller at a second level, higher than the first level.

In at least one embodiment, a system for storing input power and providing output power, such as for use with electric vehicle charging, can include an alternating current motor and a flywheel. In at least one embodiment, the motor can be configured to be electrically coupled to an alternating current power source. In at least one embodiment, the motor can have a rotor. In at least one embodiment, the motor can be configured to receive AC power from the power source. In at least one embodiment, the flywheel can be mechanically coupled to the rotor external to the motor. In at least one embodiment, the flywheel can be configured to mechanically store power received from the power source through the motor. In at least one embodiment, wherein the motor can be configured to be electrically coupled to a controller for supplying power to a load.

In at least one embodiment, the motor can be a line start synchronous motor. In at least one embodiment, the load can be an electric vehicle. In at least one embodiment, the motor can be configured to supply AC power to the controller. In at least one embodiment, the controller can convert the AC power to DC power for delivery to the load.

In at least one embodiment, the motor can be configured to receive AC power from the power source at a first level. In at least one embodiment, the motor can be configured to supply AC power to the controller at a second level, higher than the first level. In at least one embodiment, the motor can be configured to add power from the flywheel to the AC power received from the power source in order to supply the AC power to the controller at the second level. In at least one embodiment, the motor can be configured to limit the AC power received from the power source to the first level.

In at least one embodiment, a system for storing input power and providing output power, such as for use with electric vehicle charging, can include a controller, an alternating current motor, and a flywheel. In at least one embodiment, the controller can be configured to be electrically coupled to an alternating current power source and a load. In at least one embodiment, the controller can be configured to convert AC power to DC power for delivery to the load. In at least one embodiment, the motor can be electrically coupled to the controller. In at least one embodiment, the motor can have a rotor. In at least one embodiment, the motor can be configured to receive AC power from the power source through the controller. In at least one embodiment, the flywheel can be mechanically coupled to the rotor external to the motor. In at least one embodiment, the flywheel can be configured to mechanically store power received from the power source through the motor.

In at least one embodiment, the motor can be a line start synchronous motor. In at least one embodiment, the motor can be configured to receive AC power from the controller and supply AC power to the controller. In at least one embodiment, the load can be an electric vehicle.

In at least one embodiment, the controller can be configured to receive AC power from the power source at a first level. In at least one embodiment, the controller can be configured to supply DC power to the load at a second level, higher than the first level. In at least one embodiment, the controller can be configured to add power from the flywheel to the AC power received from the power source in order to supply the DC power to the load at the second level. In at least one embodiment, the controller can be configured to limit the AC power received from the power source to the first level.

In at least one embodiment, a system for storing input power and providing output power, such as for use with electric vehicle charging, can include a controller configured to be electrically coupled to an alternating current power source and a load, and at least one flywheel energy storage system configured to mechanically store power received from the power source. In at least one embodiment, the controller can be configured to convert AC power to DC power for delivery to the load. In at least one embodiment, each flywheel energy storage system can include a flywheel mechanically coupled to a rotor, and an alternating current motor electrically coupled to the controller and mechanically coupled to the rotor. In at least one embodiment, the motor can be configured to receive AC power from the power source. In at least one embodiment, the load can be an electric vehicle.

In at least one embodiment, the motor can be a line start synchronous reluctance motor. In at least one embodiment, the motor can be further configured to supply AC power to the controller. In at least one embodiment, the at least one flywheel energy storage system comprises a plurality of flywheel energy storage systems.

In at least one embodiment, each flywheel energy storage system can also include an alternating current generator electrically coupled to the controller and mechanically coupled to the rotor. In at least one embodiment, the generator can be configured to supply AC power to the controller. In at least one embodiment, the alternating current generator can be a synchronous alternating current generator.

In at least one embodiment, the rotor can be supported by at least one high temperature superconducting magnetic bearing. For example, the rotor can be axially supported at an upper end by one high temperature superconducting magnetic bearing and/or at a lower end by another high temperature superconducting magnetic bearing. In at least one embodiment, the flywheel is supported by at least one magnetic levitation bearing. For example, the flywheel can be supported from below by a repulsion mode permanent magnet levitation bearing and/or from above by an attraction mode permanent magnet levitation bearing.

In at least one embodiment, the controller can be configured to receive AC power from the power source at a first level and supply DC power to the load at a second level. In at least one embodiment, the second level can be higher than the first level. In at least one embodiment, the controller can be configured to add power from the flywheel to the AC power received from the power source in order to supply the DC power to the load at the second level. In at least one embodiment, the controller can be configured to limit the AC power received from the power source to the first level.

In at least one embodiment, a system for storing input power and providing output power, such as for use with electric vehicle charging, can include a controller, a line start synchronous alternating current motor, a flywheel, a synchronous alternating current generator, or any combination thereof. In at least one embodiment, the controller can be electrically coupled to an alternating current power source and/or a load. In at least one embodiment, the controller can convert AC power to DC power for delivery to the load at a first level.

In at least one embodiment, the line start synchronous alternating current motor can be electrically coupled to the alternating current power source. In at least one embodiment, the motor can have a first rotor and/or can receive AC power from the power source at a second level. In at least one embodiment, the second level can be lower than the first level. In at least one embodiment, the controller can limit the AC power received from the power source to the second level. In at least one embodiment, the flywheel can be mechanically coupled to the first rotor external to the motor.

In at least one embodiment, the synchronous alternating current generator can have a second rotor mechanically coupled to the flywheel. In at least one embodiment, the generator can be electrically coupled to the controller for supplying power to the load. In at least one embodiment, the load can be an electric vehicle. In at least one embodiment, the generator can supply AC power to the controller.

Other and further embodiments utilizing one or more aspects of the disclosure can be devised without departing from the spirit of Applicants' disclosure. For example, the devices, systems and methods can be implemented for numerous different types and sizes in numerous different industries. Further, the various methods and embodiments of the devices, systems and methods can be included in combination with each other to produce variations of the disclosed methods and embodiments. Discussion of singular elements can include plural elements and vice versa. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the inventions has been described. Obvious modifications and alterations to the described embodiments are available to those of ordinary skill in the art having the benefits of the present disclosure. The disclosed and undisclosed embodiments are not intended to limit or restrict the scope or applicability of the inventions conceived of by the Applicants, but rather, in conformity with the patent laws, Applicants intend to fully protect all such modifications and improvements that come within the scope or range of equivalents of the following claims.

What is claimed is:

1. A system for storing input power and providing output power, the system comprising:
a controller configured to be electrically coupled to an alternating current power source and a load, wherein the controller is configured to convert AC power to DC power for delivery to the load; and
at least one flywheel energy storage system configured to mechanically store power received from the power source, each flywheel energy storage system including—
a flywheel mechanically coupled to a rotor; and
an alternating current motor electrically coupled to the controller and mechanically coupled to the rotor, the motor being configured to receive AC power from the power source.

2. The system of claim 1, wherein the motor is a line start synchronous reluctance motor.

3. The system of claim 1, wherein the motor is further configured to supply AC power to the controller.

4. The system of claim 1, wherein each flywheel energy storage system further includes an alternating current generator electrically coupled to the controller and mechanically coupled to the rotor, the generator being configured to supply AC power to the controller.

5. The system of claim 1, wherein the rotor is supported by at least one high temperature superconducting magnetic bearing.

6. The system of claim 1, wherein the flywheel is supported by at least one magnetic levitation bearing.

7. The system of claim 1, wherein the controller is configured to receive AC power from the power source at a first level and wherein the controller is configured to supply DC power to the load at a second level, wherein the second level is higher than the first level.

8. The system of claim 7, wherein the controller is configured to add power from the flywheel to the AC power received from the power source in order to supply the DC power to the load at the second level.

9. The system of claim 7, wherein the controller is configured to limit the AC power received from the power source to the first level.

10. The system of claim 1, wherein the load is an electric vehicle.

11. A system for storing input power and providing output power, the system comprising:
a controller configured to be electrically coupled to an alternating current power source and a load, wherein the controller is configured to convert AC power to DC power for delivery to the load;
an alternating current motor electrically coupled to the controller, the motor having a rotor and being configured to receive AC power from the power source through the controller; and
a flywheel mechanically coupled to the rotor external to the motor, the flywheel being configured to mechanically store power received from the power source through the motor.

12. The system of claim 11, wherein the motor is a line start synchronous motor.

13. The system of claim 11, wherein the motor is configured to receive AC power from the controller and supply AC power to the controller.

14. The system of claim 11, wherein the controller is configured to receive AC power from the power source at a first level and wherein the controller is configured to supply DC power to the load at a second level, wherein the second level is higher than the first level.

15. The system of claim 14, wherein the controller is configured to add power from the flywheel to the AC power received from the power source in order to supply the DC power to the load at the second level.

16. The system of claim 14, wherein the controller is configured to limit the AC power received from the power source to the first level.

17. The system of claim 11, wherein the load is an electric vehicle.

18. A system for storing input power and providing output power, the system comprising:
a controller configured to be electrically coupled to an alternating current power source and a load, wherein the controller is configured to convert AC power to DC power for delivery to the load at a first level;
a line start synchronous alternating current motor configured to be electrically coupled to the alternating current power source, the motor having a first rotor and being configured to receive AC power from the power source at a second level, wherein the second level is lower than the first level;
a flywheel mechanically coupled to the first rotor external to the motor; and
a synchronous alternating current generator having a second rotor mechanically coupled to the flywheel, the generator being configured to be electrically coupled to the controller for supplying power to the load, wherein the generator is configured to supply AC power to the controller.

19. The system of claim 18, wherein the controller is configured to limit the AC power received from the power source to the second level.

20. The system of claim 18, wherein the load is an electric vehicle.
